(19) United States
(12) Patent Application Publication
(10) Pub. No.: US 2022/0083145 A1
(43) Pub. Date: Mar. 17, 2022

(54) INFORMATION DISPLAY APPARATUS USING LINE OF SIGHT AND GESTURES

(71) Applicant: NTT DOCOMO, INC., Chiyoda-ku (JP)

(72) Inventors: Yuki MATSUNAGA, Chiyoda-ku (JP); Tomohito YAMASAKI, Chiyoda-ku (JP)

(73) Assignee: NTT DOCOMO, INC., Chiyoda-ku (JP)

(21) Appl. No.: 17/421,145

(22) PCT Filed: Feb. 19, 2020
(86) PCT No.: PCT/JP2020/006399

§ 371 Date: Jul. 7, 2021

(30) Foreign Application Priority Data
Feb. 19, 2019 (JP) 2019-027275

(51) Int. Cl. G06F 3/01; G06V 40/20; G06T 19/00

(52) U.S. Cl. CPC G06F 3/017; G06T 19/006; G06V 40/28; G06F 3/013

(57) ABSTRACT

An information display apparatus includes: a display that displays an auxiliary image indicative of predetermined information such that the auxiliary image is superimposed on an external field image; a gesture detector that detects a gesture of a user; a sightline detector that detects a sightline of the user; and a controller that controls display by the display based on results of detection by the gesture detector and the sightline detector. The auxiliary image includes a first auxiliary image and a second auxiliary image that differs from the first auxiliary image, and the controller, in a case in which, while the first auxiliary image is displayed on the display being superimposed onto a first part of the user in the external field image, the gesture detector detects a display-start gesture that indicates an instruction to display the second auxiliary image on a second part that differs from the first part, invalidate the display-start gesture when the sightline detected by the sightline detector is directed outside of a predetermined region corresponding to the second part.

### TECHNICAL FIELD

The present invention relates to an information display apparatus.

### BACKGROUND ART

There are known information display apparatuses that display various types of information using augmented reality (AR) technology on the body of a user. For example, Non-Patent Document 1 discloses a technology for detecting a palm of a user using a camera and displaying a telephone keypad on the palm using AR technology. In addition, Non-Patent Document 1 discloses a technique of changing a menu by detecting the front and back sides and rotation of a palm.

### RELATED ART DOCUMENT

### Non-Patent Document

Non-Patent Document 1 Hiroshi SASAKI, “A Study on Deviceless Virtual Interface Using Human Hand for Wearable Computers,” [online], Mar. 24, 2003, Nara Institute of Science and Technology, [retrieved Nov. 14, 2018], Internet <URL: https://library.naist.jp/mylimedio/dllimedio/showpdf2.cgi/DLPDFR002510_P1-95>

### SUMMARY OF THE INVENTION

### Problem to be Solved by the Invention

The technology disclosed in Non-Patent Document 1 has a drawback in that, when a detection target is detected within the field of vision of a camera, display is changed irrespective of the intention of a user.

### Means of Solving the Problems

In order to achieve the aforementioned objects, an information display apparatus according to a suitable aspect of the present invention includes: a display configured to display an auxiliary image indicative of predetermined information such that the auxiliary image is superimposed on an external field image; a gesture detector configured to detect a gesture of a user; a sightline detector configured to detect a sightline of the user; and a controller configured to control display by the display based on results of detection by the gesture detector and the sightline detector, wherein the auxiliary image includes a first auxiliary image and a second auxiliary image that differs from the first auxiliary image, and the controller is configured to, in a case in which, while the first auxiliary image is displayed on the display being superimposed onto a first part of the user in the external field image, the gesture detector detects a display-start gesture that indicates an instruction to display the second auxiliary image on a second part that differs from the first part, invalidate the display-start gesture when the sightline detected by the sightline detector is directed outside of a predetermined region corresponding to the second part.

### Effect of the Invention

According to the information display apparatus of the present invention, even if a user accidentally performs the display-start gesture, the display-start gesture is invalidated when a sightline detected by the sightline detector is directed outside of a predetermined region corresponding to the second part, and thus, change of display from the first auxiliary image to the second auxiliary image against the intention of the user is reduced.

### BRIEF DESCRIPTION OF THE DRAWINGS

FIG. 1 is a diagram showing an appearance of a use state of an information display apparatus according to an embodiment.

FIG. 2 is a block diagram showing the information display apparatus according to the embodiment.

FIG. 3 is a diagram for describing a first display-start gesture.

FIG. 4 is a diagram showing an example of a first auxiliary image displayed on an arm that is an example of a first part of a user.

FIG. 5 is a diagram for describing a second display-start gesture.

FIG. 6 is a diagram showing an example of a second auxiliary image displayed on a hand that is an example of a second part of a user.

FIG. 7 is a diagram showing an example of a state in which a sightline of a user is not directed to the second part when the second display-start gesture is detected while the first auxiliary image is displayed.

FIG. 8 is a diagram showing an example of a state of the first auxiliary image displayed following a movement of the first part.

FIG. 9 is a diagram showing an example of a state of a sightline of the user being directed to the second part when the second display-start gesture is detected while the first auxiliary image is displayed.

FIG. 10 is a diagram showing an example of a state of the second auxiliary image that has been changed from the first auxiliary image and is displayed.

FIG. 11 is a diagram showing an example of a third auxiliary image that has been changed from the first auxiliary image and is displayed in accordance with a content-change gesture.

FIG. 12 is a diagram showing an example of a fourth auxiliary image that has been changed from the second auxiliary image and is displayed in accordance with the content-change gesture.

FIG. 13 is a diagram showing an example of an end gesture for ending display of an auxiliary image.

FIG. 14 is a flowchart showing an operation of the information display apparatus according to the embodiment.

FIG. 15 is a flowchart showing the operation of the information display apparatus according to the embodiment.

### MODES FOR CARRYING OUT THE INVENTION

### 1. Embodiment

### 1.1. Overview of Information Display Apparatus

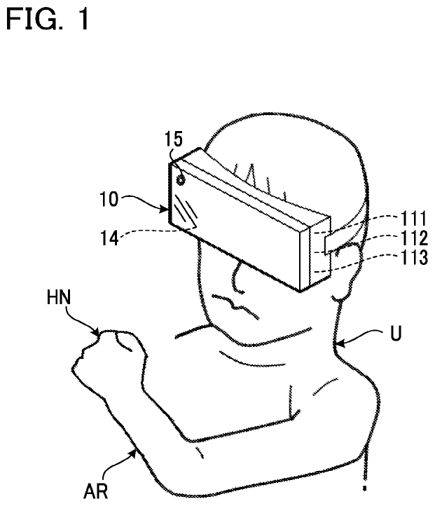

FIG. 1 is a diagram showing an appearance of a use state of an information display apparatus 10 according to an embodiment. The information display apparatus 10 shown in FIG. 1 is a see-through type head mounted display that is worn on the head of a user U. The see-through type head mounted display displays an auxiliary image visually recognized by the user U as a virtual image such that it is superimposed on an external field image using AR technology. The external field image is an image formed by external field light around the user U. The external field image visually recognized by the user U may be a real external field image or a virtual external field image displayed by capturing an image of the surroundings of the user U. That is, the information display apparatus 10 may be any of a video see-through type and an optical see-through type.

The information display apparatus 10 detects a gesture of the user U and displays the auxiliary image. Here, the external field image includes a predetermined part of the user U as a virtual or real image, and the auxiliary image is displayed being superimposed on the predetermined part. In the present embodiment, the predetermined part is set to an arm AR and a hand HN of the user U. It is of note that a “gesture” refers to a series of actions from a certain state of the predetermined part of the user U to a different state.

The information display apparatus 10 displays auxiliary images on different parts of the user U while changing the auxiliary images. Here, different auxiliary images and gestures are allocated to the parts in advance. In addition, the information display apparatus 10 is capable of detecting a sightline of the user U. When, while one of the auxiliary images is displayed, a gesture for displaying another auxiliary image is detected, the information display apparatus 10 determines whether to change the display from the one to the other auxiliary image on the basis of the sightline of the user U. Accordingly, the changing of auxiliary images which is not intended by the user U is reduced.

### 1.2. Hardware Configuration of System Using Information Display Apparatus

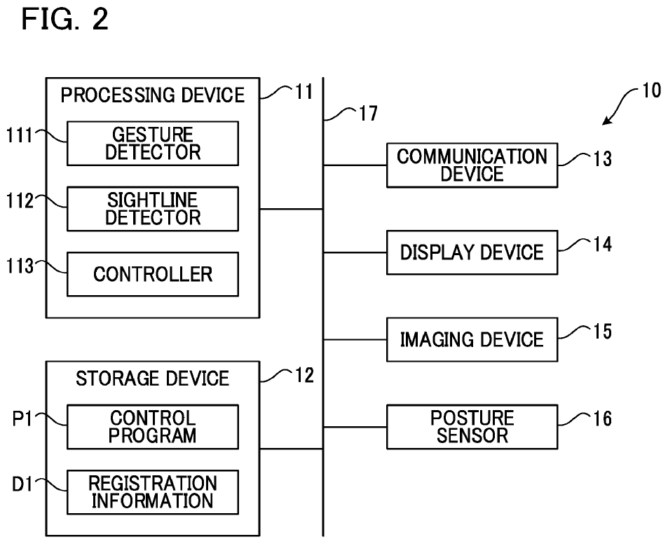

FIG. 2 is a block diagram showing the information display apparatus 10 according to the embodiment. As shown in FIG. 2, the information display apparatus 10 includes a processing device 11, a storage device 12, a communication device 13, a display device 14, an imaging device 15, a posture sensor 16, and a bus 17 through which these devices are connected. The bus 17 may be constituted of a single bus or of different buses between devices. It is to be noted that, although not illustrated, the information display apparatus 10 includes various types of hardware or various types of software for generating or acquiring various types of information, such as time information, information on day of a week, weather information, and email information, which are used for auxiliary images (described later).

The processing device 11 is a processor that controls the overall information display apparatus 10 and may be configured as a single chip or as multiple chips, for example. For example, the processing device 11 may be configured as a central processing unit (CPU) including an interface with peripheral devices, an arithmetic operation device, a register, and the like. It is to be noted that some or all of the functions of the processing device 11 may be realized by hardware such as a digital signal processor (DSP), an application-specific integrated circuit (ASIC), a programmable logic device (PLD), and a field programmable gate array (FPGA). The processing device 11 executes various types of processing in parallel or in series.

The storage device 12 is a recording medium readable by the processing device 11 and stores programs including a control program P1 executed by the processing device 11 and various types of data including registration information D1 used by the processing device 11. The storage device 12 may be constituted of one or more storage circuits such as a read only memory (ROM), an erasable programmable ROM (EPROM), an electrically erasable programmable ROM (EEPROM), and a random access memory (RAM), for example. It is to be noted that the control program P1 and the registration information D1 will be described in detail later in “1.3. Functions of the information display apparatus 10”.

The communication device 13 is an apparatus that communicates with other devices and has a function of communicating with other devices through a network such as a mobile communication network or the Internet, and a function of communicating with other devices using short-range wireless communication. As short-range wireless communication, for example, Bluetooth (registered trademark), ZigBee (registered trademark), WiFi (registered trademark), or the like may be conceived. Furthermore, the communication device 13 may be provided as necessary, and hence, it may be omitted.

The display device 14 is an example of a “display” that displays various auxiliary images visually recognized by the user U as virtual images such that they are superimposed on an external field image. The display device 14 displays various auxiliary images under the control of the processing device 11. The display device 14 may include, for example, various display panels such as a liquid crystal display panel and an organic electroluminescent (EL) display panel, an optical scanner, or the like. Here, the display device 14 appropriately includes various components such as a light source and an optical system for realizing a see-through type head-mounted display.

The imaging device 15 is a device that captures an image of a subject and outputs data indicative of the captured image. The imaging device 15 may include, for example, an imaging optical system and an imaging element. The imaging optical system is an optical system including at least one imaging lens and may include various optical elements such as a prism or may include a zoom lens, a focus lens, and the like. The imaging element may be configured as a charge coupled device (CCD) image sensor or a complementary MOS (CMOS) image sensor, for example. Here, a region that can be imaged by the imaging device 15 includes a part or all of a region that can be displayed by the display device 14.

The posture sensor 16 is a sensor that outputs data in response to a change in the posture of the display device 14 or the imaging device 15. The posture sensor 16 may include, for example, one or both of an acceleration sensor and a gyro sensor. For example, a sensor that detects an acceleration in each direction of three axes orthogonal to one another may be suitably used as the acceleration sensor. For example, a sensor that detects an angular velocity or an angular acceleration around each of 3 axes orthogonal to one another may be suitably used as the gyro sensor. It is to be noted that the posture sensor 16 may be provided as necessary, and hence, it may be omitted.

### 1.3. Functions of Information Display Apparatus

The processing device 11 serves as a gesture detector 111, a sightline detector 112, and a controller 113 by executing the control program P1 read from the storage device 12. Accordingly, the information display apparatus 10 includes the gesture detector 111, the sightline detector 112, and the controller 113.

The gesture detector 111 detects a gesture of the user U. More specifically, the gesture detector 111 detects a predetermined gesture of the user U on the basis of data from the imaging device 15 and the registration information D1 from the storage device 12. For example, the gesture detector 111 may identify the positions and shapes of the arm AR and the hand HN of the user U from a captured image indicated by data from the imaging device 15 using the registration information D1 and detect a gesture in which a speed of changes in the positions and the shapes become equal to or greater than a predetermined speed on the basis of the changes in the positions and the shapes. Here, since the gesture detector 111 does not detect a gesture when the speed of changes in the positions and shapes of the arm AR and the hand HN of the user U is less than the predetermined speed, it is possible to reduce erroneous detection of the gesture detector 111.

The gesture detector 111 of the present embodiment can detect four gestures: a first display-start gesture GES1; a second display-start gesture GES2; a content-change gesture GES3; and an end gesture GES4, which will be described later. The four gestures are classified into three types of image display: display start, content change, and end start. Information about these gestures is included in the registration information D1 as gesture information. For example, the gesture information may be set in advance as initial settings or may be information acquired when the imaging device 15 images any gesture and registered for each user. It is to be noted that the number of modes of gestures allocated for each type may be one or more and is not limited to the aforementioned number. In addition, a mode of each gesture is not limited to an example described below and may be combined with a gesture type (display start, content change, or end) in a freely selected manner. For example, an image processing technique such as template matching can be used for detection of a gesture in the gesture detector 111. In this case, the gesture information included in the registration information D1 may include information about a template image used for template matching, for example. Furthermore, a criterion for determination of detection of a gesture in the gesture detector 111 may be changed in accordance with results of machine learning or the like, for example. In addition, it is possible to increase gesture detection accuracy in the gesture detector 111 by detecting a gesture using detection results of the aforementioned posture detector 16 as well.

The sightline detector 112 detects a sightline of the user U. In the present embodiment, since positional relationships among the display device 14, the imaging device 15, and the head of the user U are fixed, a predetermined position PC set in a field of vision FV that will be described below is used as a position in the direction of the sightline. It is to be noted that the sightline detector 112 may detect a movement of the eyes of the user U using an imaging element or the like and detect a sightline of the user U on the basis of the detection result.

The controller 113 controls display of the display device 14 on the basis of detection results of the gesture detector 111 and the sightline detector 112. Specifically, when the gesture detector 111 detects a predetermined gesture in a state in which the display device 14 is not caused to display an auxiliary image, the controller 113 causes the display device 14 to display an auxiliary image corresponding to the gesture irrespective of a detection result of the sightline detector 112. On the other hand, when the gesture detector 111 detects a predetermined gesture in a state in which the display device 14 is caused to display an auxiliary image, the controller 113 determines whether a detection result of the sightline detector 112 satisfies predetermined conditions. Then, the controller 113 causes the display device 14 to display an auxiliary image corresponding to the gesture when the predetermined conditions are satisfied. On the other hand, when the predetermined conditions are not satisfied, the controller 113 does not display or change the auxiliary image corresponding to the gesture. The controller 113 of the present embodiment causes the display device 14 to display a first auxiliary image G1, a second auxiliary image G2, a third auxiliary image G3, and a fourth auxiliary image G4, which will be described later as auxiliary images. Hereinafter, each gesture and each auxiliary image will be described in detail.

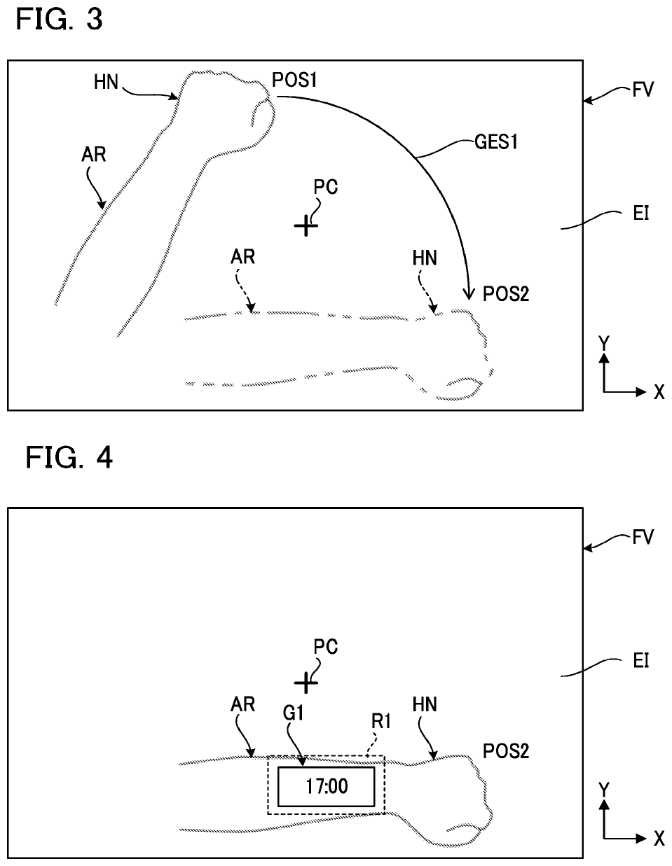

FIG. 3 is a diagram for describing the first display-start gesture GES1. The first display-start gesture GES1 is a display-start gesture that indicates an instruction to display the first auxiliary image G1, which will be described later, on a first part R1 of the user U, which will be described later. FIG. 3 illustrates an example of a state in which the first display-start gesture GES1 is seen in the field of vision FV of the user U when no auxiliary image is displayed. The field of vision FV is a region in an external field image EI in which an auxiliary image can be displayed being superposed thereon. The field of vision FV may be, for example, a region that can be displayed by the display device 14 or a region that can be imaged by the imaging device 15. The field of vision FV or the external field image EI shown in FIG. 3 has a horizontally long rectangular shape. As shown in FIG. 3, the horizontal direction of the field of vision FV or the external field image EI is represented as an X direction and the vertical direction thereof is represented as a Y direction. As shown in FIG. 3, the first display-start gesture GES1 is an action of changing the arm AR and the hand HN from a state POS1 indicated by a solid line in FIG. 3 to a state POS2 indicated by a line with alternating long and two short dashes in FIG. 3. The first display-start gesture GES1 of the present embodiment is an action that is generally performed when the user looks at a wristwatch. Here, the state POS1 is a state in which the hand HN is stretched out in front of the user U. The state POS2 is a state in which the hand HN is pulled nearer to the user U than in the state POS1.

FIG. 4 is a diagram showing an example of the first auxiliary image G1 displayed on the arm AR, which is an example of the first part R1 of the user U. When the aforementioned first display-start gesture GES1 is detected in a state in which no other auxiliary images are displayed, the first auxiliary image G1 is displayed on the first part R1 set to the arm AR that is in the state POS2, as shown in FIG. 4. In the example shown in FIG. 4, the first part R1 is set to the wrist part of the arm AR and the first auxiliary image G1 is an image representative of time. Thus, the controller 113 causes the display device 14 to display the first auxiliary image G1 on the first part R1 of the user U in the external field image EI when the gesture detector 111 detects the first display-start gesture GES1. It is to be noted that, in a state in which an auxiliary image other than the first auxiliary image G1 is displayed, it is determined whether the first auxiliary image G1 is to be displayed taking into account a direction of a sightline of the user U, similarly to the change operation from the first auxiliary image G1 to the second auxiliary image G2, which will be described later.

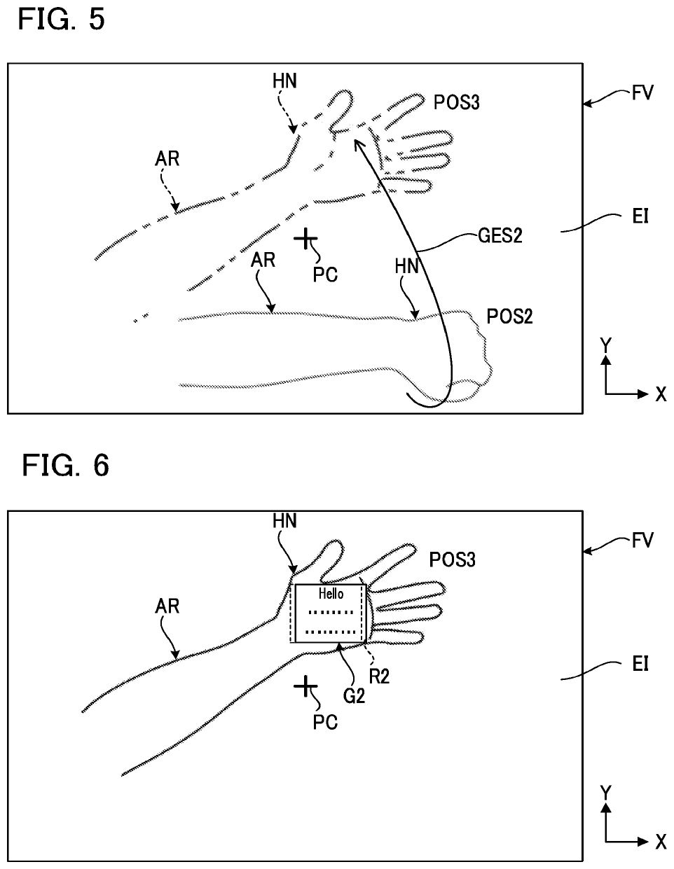

FIG. 5 is a diagram for describing the second display-start gesture GES2. The second display-start gesture GES2 is a display-start gesture that indicates an instruction to display the second auxiliary image G2, which will be described later, on a second part R2 of the user U, which will be described later. FIG. 5 illustrates an example of a state in which the second display-start gesture GES2 is seen in the field of vision FV of the user U when no auxiliary image is displayed. As shown in FIG. 5, the second display-start gesture GES2 is an action of changing the arm AR and the hand HN from the state POS2 indicated by a solid line in FIG. 5 to a state POS3 indicated by a line with alternating long and two short dashes in FIG. 5. The second display-start gesture GES2 of the present embodiment is an action performed when the user looks at the palm of the hand HN. Here, although the state POS2 is as described above, the hand HN when the second display-start gesture GES2 starts is not limited to being in a fist, and it may be open. The state POS3 is a state in which the hand HN is open with the fingertips of the hand HN more directed to the front of the user U than in the state POS2.

FIG. 6 is a diagram showing an example of the second auxiliary image G2 displayed on the hand HN, which is an example of the second part R2 of the user U. When the aforementioned second display-start gesture GES2 is detected in a state in which no other auxiliary images are displayed, the second auxiliary image G2 is displayed on the second part R2 set to the hand HN that is in the state POS3, as shown in FIG. 6. FIG. 5 illustrates a case in which the second part R2 is set to the palm part of the hand HN and the second auxiliary image G2 is an image representative of email.

Here, the first part R1 and the second part R2 are parts on the lateral the same side (the left side in the present embodiment) of the user U. Accordingly, it is possible to perform display using only the arm AR, the hand HN, or the like on one side to which the first part R1 and the second part R2 belong even in a situation in which an arm, a hand, or the like on the side opposite the side to which the first part R1 and the second part R2 belong cannot be used. As a result, it is possible to improve convenience for the user U as compared to a case in which the first part R1 and the second part R2 are parts, such as an arm or a hand, on different lateral sides.

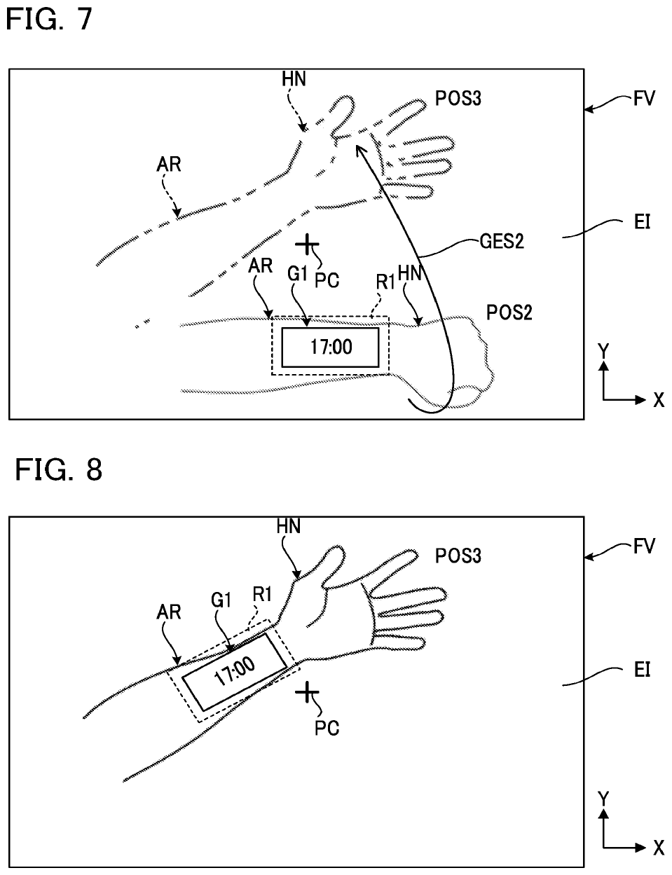

FIG. 7 is a diagram showing an example of a state in which a sightline of the user U is not directed to the second part R2 when the second display-start gesture GES2 is detected while the first auxiliary image G1 is displayed. FIG. 8 is a diagram showing an example of a state of the first auxiliary image G1 displayed following a movement of the first part R1. In a state in which the first auxiliary image G1 is displayed, the second auxiliary image G2 is not displayed when the position PC of the sightline of the user U is not directed to the second part R2 even when the second display-start gesture GES2 is detected, as shown in FIG. 7. In this case, the state in which the first auxiliary image G1 is displayed continues, as shown in FIG. 8. Here, the position of the first auxiliary image G1 moves following a movement of the arm AR.

Thus, the controller 113 changes the position of an auxiliary image following a movement (change in the position) of a part of the user U on which the auxiliary image is superimposed in the external field image EI. Accordingly, it is possible to provide a display state as if an object including the first auxiliary image G1 or the second auxiliary image G2 were put on the body of the user U even when the user U moves the first part R1 or the second part R2.

It is determined whether a sightline of the user U is directed to the second part R2 according to whether a state in which the position PC is located within a predetermined region (a region surrounded by a dotted line in the illustrated example) superimposed on the second part R2 continues for a predetermined period or longer (e.g., 1 second or longer). Accordingly, when a state of a sightline of the user U being directed outside of a predetermined region corresponding to the second part R2 continues for the predetermined period or longer, the controller 113 determines that the sightline is directed outside of the predetermined region. Accordingly, change of display from the first auxiliary image G1 to the second auxiliary image G2 against an intention of the user U due to unstable sightline of the user U is reduced. It is to be noted that the controller 113 also determines whether a sightline is directed to the first part R1 on the basis of whether a state of the sightline of the user U being directed inside of a predetermined region superimposed on the first part R1 continues for a predetermined period or longer.

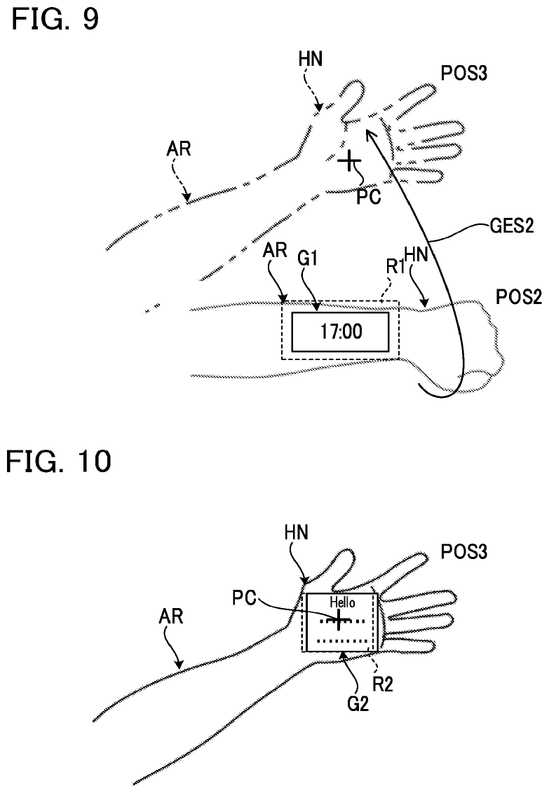

FIG. 9 is a diagram showing an example of a state of a sightline of the user U being directed to the second part R2 when the second display-start gesture GES2 is detected while the first auxiliary image G1 is displayed. FIG. 10 is a diagram showing an example of a state of the second auxiliary image G2 that has been changed from the first auxiliary image G1 and is displayed. In a state in which the first auxiliary image G1 is displayed, when the second display-start gesture GES2 is detected, as shown in FIG. 9, the first auxiliary image G1 is changed to the second auxiliary image G2 and the second auxiliary image G2 is displayed, as shown in FIG. 10, when the position PC of the sightline of the user U is directed to the second part R2.

In this manner, the controller 113 determines whether a sightline of the user U is directed to the second part R2 when the gesture detector 111 detects the second display-start gesture GES2 while the first auxiliary image G1 is displayed. Then, the controller 113 causes the display device 14 to display the second auxiliary image G2 on the second part R2 in the external field image EI when the sightline is directed to the second part R2. In other words, when the gesture detector 111 detects the second display-start gesture GES2 while the display device 14 displays the first auxiliary image G1 such that it is superimposed on the first part R1 of the user U in the external field image ET, the controller 113 invalidates the second display-start gesture GES2 when a sightline detected by the sightline detector 112 is directed outside of a predetermined region corresponding to the second part R2. Accordingly, when the user U wants to change the display from the first auxiliary image G1 to the second auxiliary image G2, the user U should intentionally direct a sightline to the second part R2 as well as performing the second display-start gesture GES2. As a result, change of display from the first auxiliary image G1 to the second auxiliary image G2 against an intention of the user U is reduced even when the user U accidentally performs the second display-start gesture GES2.

Here, since the second part R2 is a display position of the second auxiliary image G2, an action of directing a sightline to the second part R2 when the user U wants a change of display from the first auxiliary image G1 to the second auxiliary image G2 is a very natural action for the user U. Accordingly, even when a user's action of directing a sightline to the second part R2 is required in changing the display from the first auxiliary image G1 to the second auxiliary image G2, operability is not deteriorated. In addition, when display is changed from the first auxiliary image G1 to the second auxiliary image G2, a display position of an auxiliary image changes from the first part R1 to the second part R2. Accordingly, it can be said that changing of a display position of an auxiliary image from the first part R1 to the second part R2 against an intention of the user U is reduced in the information display apparatus 10. It is to be noted that, with respect to change from the third auxiliary image G3 to the second auxiliary image G2, and change from the second auxiliary image G2 or the fourth auxiliary image G4 to the first auxiliary image G1, change against an intention of the user U is reduced in the same manner.

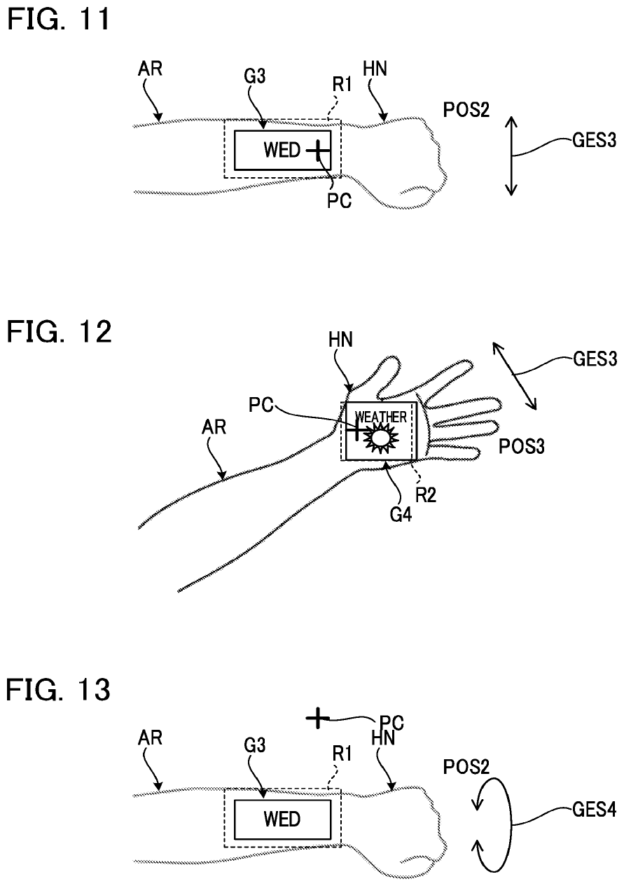

FIG. 11 is a diagram showing an example of the third auxiliary image G3 that has been changed from the first auxiliary image G1 and is displayed according to the content-change gesture GES3. The content-change gesture GES3 is a gesture indicating an instruction to change displayed content. In a state in which the first auxiliary image G1 is displayed, when the content-change gesture GES3 is detected, the first auxiliary image G1 is changed to the third auxiliary image G3 and the third auxiliary image G3 is displayed, as shown in FIG. 11. The content-change gesture GES3 in the present embodiment is an action of slightly waving the hand HN. FIG. 11 illustrates a case in which the third auxiliary image G3 is an image representative of a day of the week. Here, the third auxiliary image G3 is displayed on the first part R1. In addition, although not illustrated, when the content-change gesture GES3 is detected in a state in which the third auxiliary image G3 is displayed, the third auxiliary image G3 is changed to the first auxiliary image G1, and the first auxiliary image G1 is displayed. It is to be noted that change between the first auxiliary image G1 and the third auxiliary image G3 may be performed based only on a detection of the content-change gesture GES3 or be performed in a case in which the content-change gesture GES3 is detected and a sightline of the user U is directed to the first part R1.

FIG. 12 is a diagram showing an example of the fourth auxiliary image G4 that has been changed from the second auxiliary image G2 and is displayed according to the content-change gesture GES3. When the content-change gesture GES3 is detected in a state in which the second auxiliary image G2 is displayed, the second auxiliary image G2 is changed to the fourth auxiliary image G4, and the fourth auxiliary image G4 is displayed, as shown in FIG. 12. In FIG. 12, an example is given of a case in which the fourth auxiliary image G4 is an image representative of weather. Here, the fourth auxiliary image G4 is displayed on the second part R2. In addition, although not illustrated, when the content-change gesture GES3 is detected in a state in which the fourth auxiliary image G4 is displayed, the fourth auxiliary image G4 is changed to the second auxiliary image G2, and the second auxiliary image G2 is displayed. It is to be noted that change between the second auxiliary image G2 and the fourth auxiliary image G4 may be performed based only on a detection of the content-change gesture GES3 or be performed in a case in which the content-change gesture GES3 is detected and a sightline of the user U is directed to the second part R2.

In this manner, the controller 113 changes the first auxiliary image G1 to the third auxiliary image G3, which is another auxiliary image, when the gesture detector 111 detects the content-change gesture GES3, which differs from both the first display-start gesture GES1 and the second display-start gesture GES2, while the first auxiliary image G1 is displayed; the controller 113 changes the second auxiliary image G2 to the fourth auxiliary image G4, which is another auxiliary image, when the gesture detector 111 detects the content-change gesture GES3 while the second auxiliary image G2 is displayed. Accordingly, it is possible to display a plurality of types of information on the first part R1 or the second part R2 by changing the information. As a result, it is possible to enlarge displayed content of each piece of information such that it is easily viewed as compared to a case in which a plurality of types of information are simultaneously displayed.

Here, the content-change gesture GES3 is a gesture using the first part R1 or the second part R2. Accordingly, even in a situation in which one arm, one hand or the like on the side opposite the side to which the first part R1 or the second part R2 belongs, from among the arm or the hand on the left side of the user U and the arm or the hand on the right side, cannot be used, both display and change of display can be performed using only one arm AR or one hand HN on the side to which the first part R1 or the second part R2 belongs. As a result, it is possible to improve convenience for the user U as compared to a case in which display and change of display are performed using both arms, hands, or the like.

FIG. 13 is a diagram showing an example of the end gesture GES4 for ending display of an auxiliary image. The end gesture GES4 is a gesture indicating an instruction to end display. When the end gesture GES4 is detected, as shown in FIG. 13, display of an auxiliary image ends. The end gesture GES4 of the present embodiment is an action of repeating an action of twisting the arm AR to shake the hand HN. In FIG. 13, there is illustrated a case in which the end gesture GES4 is detected in a state in which the third auxiliary image G3 is displayed. In this example, display of the third auxiliary image G3 ends. When an auxiliary image other than the third auxiliary image G3 is displayed, display of the auxiliary image ends when the end gesture GES4 is detected in the same manner.

In this manner, the controller 113 ends display of the first auxiliary image G1 or the second auxiliary image G2 when the gesture detector 111 detects the end gesture GES4 that differs from the first display-start gesture GES1 and the second display-start gesture GES2, while the first auxiliary image G1 or the second auxiliary image G2 is displayed. Accordingly, it is possible to end display of the first auxiliary image G1 or the second auxiliary image G2 at a timing intended by the user U. Furthermore, convenience for the user U is higher than in a case in which display is ended using a physical switch or the like.

### 1.4. Operation of Information Display Apparatus

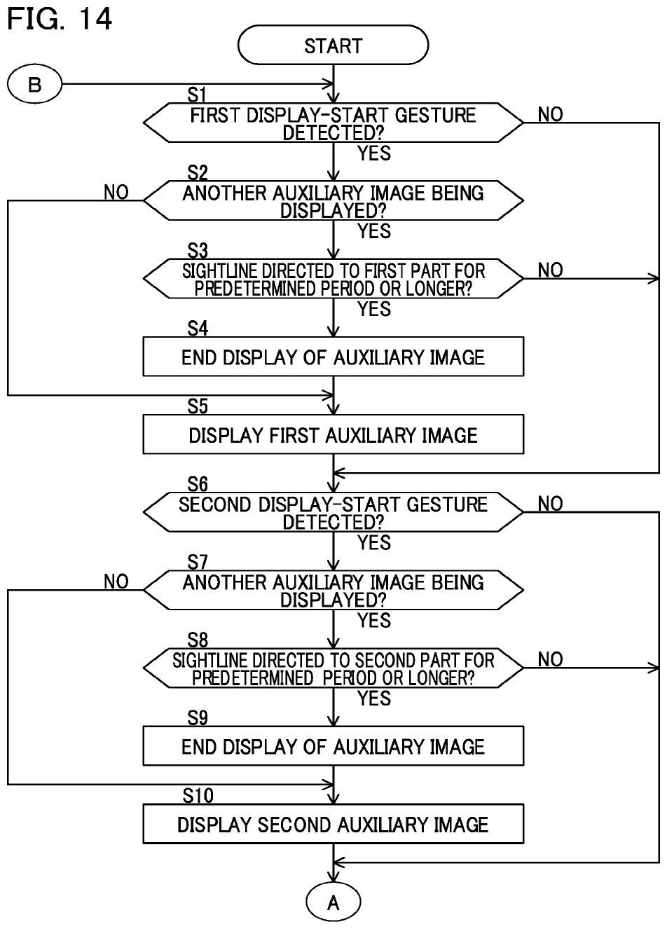

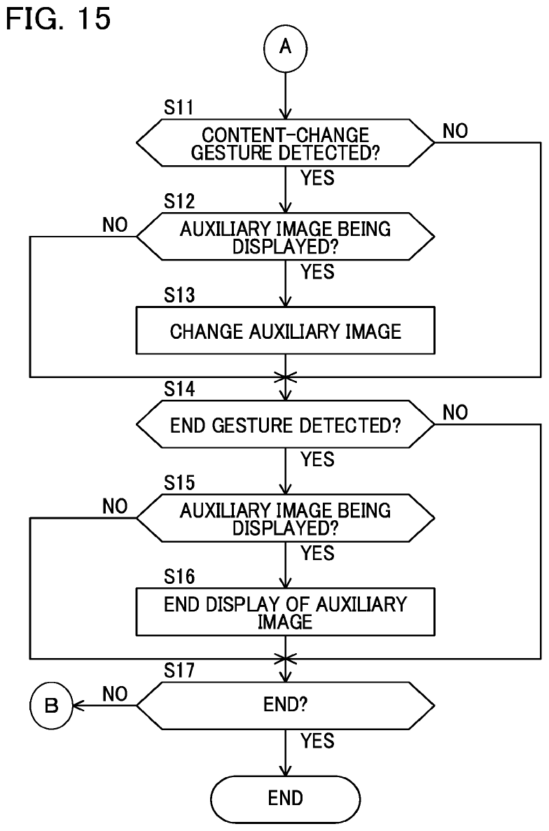

FIG. 14 and FIG. 15 are flowcharts showing an operation of the information display apparatus 10 according to the embodiment. Hereinafter, a flow of display control performed by the controller 113 will be described on the basis of FIG. 14 and FIG. 15. First, the controller 113 determines whether the first display-start gesture GES1 is detected (S1), as shown in FIG. 14. When the first display-start gesture GES1 is not detected (NO in S1), the controller 113 proceeds to step S6, which will be described later, and determines whether the second display-start gesture GES2 is detected. On the other hand, when the first display-start gesture GES1 is detected (YES in S1), the controller 113 determines whether an auxiliary image different from the first auxiliary image G1 is displayed (S2).

When no other auxiliary images are being displayed (NO in S2), the controller 113 proceeds to step S5, which will be described later, and causes the display device 14 to display the first auxiliary image G1. On the other hand, when another auxiliary image is being displayed (YES in S2), the controller 113 determines whether a state in which a sightline of the user U is directed to the first part R1 continues for a predetermined period or longer (S3).

When the state does not continue for the predetermined period or longer (NO in S3), the controller 113 proceeds to step S6, which will be described later, and determines whether the second display-start gesture GES2 is detected. On the other hand, when the state continues for the predetermined period or longer (YES in S3), the controller 113 ends display of the auxiliary image that is being displayed (S4), causes the display device 14 to display the first auxiliary image G1 (S5), and then proceeds to step S6, which will be described later. It is to be noted that the order of steps S4 and S5 may be reversed.

In step S6, the controller 113 determines whether the second display-start gesture GES2 is detected. When the second display-start gesture GES2 is not detected (NO in S6), the controller 113 proceeds to step S11, which will be described later, and determines whether the content-change gesture GES3 is detected. On the other hand, when the second display-start gesture GES2 is detected (YES in S6), the controller 113 determines whether another auxiliary image, different from the second auxiliary image G2 is being displayed (S7).

When no other auxiliary image are being displayed (NO in S7), the controller 113 proceeds to step S10, which will be described later, and causes the display device 14 to display the second auxiliary image G2. On the other hand, when another auxiliary image is being displayed (YES in S7), the controller 113 determines whether a state in which a sightline of the user U is directed to the second part R2 continues for a predetermined period or longer (S8).

When the state does not continue for the predetermined period or longer (NO in S8), the controller 113 proceeds to step S11, which will be described later, and determines whether the content-change gesture GES3 is detected. On the other hand, when the state continues for the predetermined period or longer (YES in S8), the controller 113 ends display of the auxiliary image that is being displayed (S9), causes the display device 14 to display the second auxiliary image G2 (S10), and then proceeds to step S11. It is to be noted that the order of steps S9 and S10 may be reversed.

As shown in FIG. 15, the controller 113 determines whether the content-change gesture GES3 is detected in step S11. When the content-change gesture GES3 is not detected (NO in S11), the controller 113 proceeds to step S14, which will be described later, and determines whether the end gesture GES4 is detected. On the other hand, when the content-change gesture GES3 is detected (YES in S11), the controller 113 determines whether any of the first auxiliary image G1, the second auxiliary image G2, the third auxiliary image G3, and the fourth auxiliary image G4 is being displayed (S12).

When no auxiliary image is being displayed (NO in S12), the controller 113 proceeds to step S14, which will be described later, and determines whether the end gesture GES4 is detected. On the other hand, when one of the auxiliary images is being displayed (YES in S12), the controller 113 changes the auxiliary image that is being displayed (S13) to another one and then proceeds to step S14, which will be described later. Here, when the first auxiliary image G1 is being displayed, the controller 113 changes the first auxiliary image G1 to the third auxiliary image G3. When the second auxiliary image G2 is being displayed, the controller 113 changes the second auxiliary image G2 to the fourth auxiliary image G4. In addition, when the third auxiliary image G3 is being displayed, the controller 113 changes the third auxiliary image G3 to the first auxiliary image G1. When the fourth auxiliary image G4 is being displayed, the controller 113 changes the fourth auxiliary image G4 to the second auxiliary image G2.

In step S14, the controller 113 determines whether the end gesture GES4 is detected. When the end gesture GES4 is not detected (NO in S14), the controller 113 proceeds to step S17, which will be described later. On the other hand, when the end gesture GES4 is detected (YES in S14), the controller 113 determines whether any auxiliary image is being displayed as in step S12 described above (S15). When no auxiliary image is being displayed (NO in S15), the controller 113 proceeds to step S17, which will be described later. On the other hand, when one of the auxiliary images is being displayed (YES in S15), the controller 113 ends display of the auxiliary image that is being displayed (S16) and then proceeds to step S17, which will be described later.

In step S17, the controller 113 determines whether there is an end instruction for ending detection of a gesture from the user U. The end instruction may be received through an input device of the information display apparatus 10, such as a switch, which is not shown, for example. Then, the controller 113 returns to step S1 described above when the end instruction is not present (NO in S17) and ends detection when the end instruction is present (YES in S17).

### 2. Modifications

The present invention is not limited to each embodiment exemplified above. Specific aspects of modification will be exemplified below. Two or more aspects freely selected from the examples below may be combined.

(1) In the above-described embodiment, a case in which the first auxiliary image G1 is an image representative of time, the second auxiliary image G2 is an image representative of email, the third auxiliary image G3 is an image representative of a day of the week, and the fourth auxiliary image G4 is an image representative of weather is exemplified. Displayed content of each auxiliary image is not limited to the examples and can be freely selected. Furthermore, display of one or both of the third auxiliary image G3 and the fourth auxiliary image G4 may be omitted.

(2) In the above-described embodiment, a case in which an auxiliary image is displayed on a wrist or a palm of a hand of the user U is exemplified. A part on which an auxiliary image is displayed may be a part of the body of the user U, and the part on which an auxiliary image is displayed is not limited to the example and may be a foot or the like, for example.

(3) In the above-described embodiment, a case in which an auxiliary image is displayed on a part of the left side body of the user U is exemplified. The present invention is not limited to the example, and an auxiliary image may be displayed on a part of the right side body of the user U or displayed on parts of the body of the user U on both the left and right sides, for example.

(4) The block diagram used to illustrate each embodiment described above shows blocks of functional units. These functional blocks (components) are realized by any combination of hardware and/or software. In addition, means for realizing each functional block is not particularly limited. That is, each functional block may be realized by a single device that is physically and/or logically connected or realized by connecting two or more physically and/or logically divided devices directly and/or indirectly (e.g., in a wired and/or wireless manner). In addition, the word “apparatus” used to describe each embodiment described above may be replaced with other terms such as “circuit”, “device”, or “unit”.

(5) In the processing procedures, sequences, flowcharts, and the like in each embodiment described above, the order may be changed, unless there is conflict. For example, with respect to the method described in the specification, elements of various steps are presented in illustrative order, and the method is not limited to the presented specific order.

(6) In each embodiment described above, input/output information and the like may be stored in a specific place (e.g., a memory). Input/output information and the like can be overwritten, updated, or added. Output information and the like may be deleted. Input information and the like may be transmitted to other devices.

(7) In each embodiment described above, determination may be performed using a value represented by 1 bit (0 or 1), performed using Boolean (true or false), or performed according to comparison between numerical values (e.g., comparison with a predetermined value).

(8) Although the storage device 12 is a recording medium readable by the processing device 11 and a ROM, a RAM and the like are exemplified in each embodiment described above, the storage device 12 is a flexible disc, a magneto-optical disk (e.g., a compact disc, a digital versatile disk, and a Blu-ray (registered trademark) disc), a smart card, a flash memory device (e.g., a card, a stick, and a key drive), a compact disc-ROM (CD-ROM), a register, a removable disk, a hard disk, a floppy (registered trademark) disk, a magnetic strip, a database, a server, and other appropriate storage media. In addition, a program may be transmitted from a network. Furthermore, the program may be transmitted from a communication network via an electronic communication circuit.

(9) Information, signals and the like described in each embodiment described above may be represented using any of various different techniques. For example, data, instructions, commands, information, signals, bits, symbols, chips, and the like mentioned in the above-described description may be represented by voltages, currents, electromagnetic waves, magnetic fields or magnetic particles, photo-fields or photons, or any combination thereof.

(10) Each function illustrated in FIG. 2 may be realized by any combination of hardware and software. In addition, each function may be realized by a single device, or by two or more devices constituted of separate bodies.

(11) The program exemplified in each embodiment described above should be broadly interpreted such that it means commands, a command set, code, code segments, program code, a subprogram, a software module, applications, software applications, a software package, routines, subroutines, objects, executable files, execution threads, procedures, functions, or the like, irrespective of whether the program is called software, firmware, middleware, microcode or hardware description language or is called by other names. In addition, software, commands and the like may be transmitted and received via transmission media. For example, when software is transmitted from a website, a server, or another remote source using wired techniques such as using a coaxial cable, an optical fiber cable, or a twisted pair cable, a digital subscriber line (DSL), and/or wireless techniques such as infrared rays, wireless and microwaves, or the like, these wired techniques and/or wireless techniques are included in the definition of transmission media.

(12) In each embodiment described above, information, parameters and the like may be represented by absolute values, be represented by relative values with respect to predetermined values, or be represented by different information corresponding thereto. For example, wireless resources may be indicated using an index.

(13) In each embodiment described above, a case in which the information display apparatus 10 is a mobile station is included. The mobile station may also be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms.

(14) In each embodiment described above, the term “connected” or any modification thereof, means every direct or indirect connection or coupling between two or more elements and can include presence of one or more intermediate elements between two elements “connected” to each other. Connection between elements may be made physically, logically or in combination thereof. When used in the specification, two elements can be considered to be “connected” to each other by using one or more wires, cables and/or printed electrical connection and using electromagnetic energy such as electromagnetic energy having wavelengths of a radio frequency domain, a microwave range and an optical (both visible and invisible rays) region as several non-limiting and non-exhaustive examples.

(15) In each embodiment described above, “on the basis of” does not mean “only on the basis of” unless mentioned otherwise. In other words, “on the basis of” means both “only on the basis of” and “at least on the basis of”.

(16) Any reference to elements using the terms “first”, “second” and the like used in this specification does not limit the amounts or order of the elements. These terms may be used as a convenient way to distinguish between two or more elements in this specification. Accordingly, reference to the first and second elements does not mean that only two elements can be employed or that the first element should precede the second element in any form.

(17) In each embodiment described above, the terms “including,” “comprising” and modifications thereof are intended to be inclusive like the term “including” as long as they are used in this specification or the claims. Furthermore, the term “or” used in this specification or the claims is intended not to be the exclusive OR.

(18) When articles such as “a,” “an” and “the” are added in the English translation, for example, in the entire application, these articles include plurals, unless the context clearly indicates otherwise.

(19) It is apparent to those skilled in the art that the present invention is not limited by embodiments described in the specification. Various modifications and variations can be made in the present invention without departing from the spirit or scope of the invention as claimed in the claims. Accordingly, description of the present specification is for the purpose of illustrative description and does not have any restrictive meaning with respect to the present invention. In addition, a plurality of aspects selected from aspects exemplified in the specification may be combined.

### DESCRIPTION OF REFERENCE SIGNS

10 Information display apparatus
14 Display device (display)
111 Gesture detector
112 Sightline detector
113 Controller
AR Arm
G1 First auxiliary image
G2 Second auxiliary image
G3 Third auxiliary image
G4 Fourth auxiliary image
GES1 First display-start gesture
GES2 Second display-start gesture
GES3 Content-change gesture
GES4 End gesture
HN Hand
R1 First part
R2 Second part
U User

1. An information display apparatus comprising:
a display configured to display an auxiliary image indicative of predetermined information such that the auxiliary image is superimposed on an external field image;
a gesture detector configured to detect a gesture of a user;
a sightline detector configured to detect a sightline of the user; and
a controller configured to control display by the display based on results of detection by the gesture detector and the sightline detector,
wherein the auxiliary image includes a first auxiliary image and a second auxiliary image that differs from the first auxiliary image, and
wherein the controller is configured to, in a case in which, while the first auxiliary image is displayed on the display being superimposed onto a first part of the user in the external field image, the gesture detector detects a display-start gesture that indicates an instruction to display the second auxiliary image on a second part that differs from the first part, invalidate the display-start gesture when the sightline detected by the sightline detector is directed outside of a predetermined region corresponding to the second part.

2. The information display apparatus according to claim 1, wherein the controller is configured to determine that the sightline is directed outside of the predetermined region in a case in which a state of the sightline being directed outside of the predetermined region continues for a predetermined period or longer.

3. The information display apparatus according to claim 1, wherein the controller is configured to change the first auxiliary image or the second auxiliary image to another auxiliary image in a case in which the gesture detector detects a content-change gesture that indicates an instruction to change displayed content while the first auxiliary image or the second auxiliary image is displayed.

4. The information display apparatus according to claim 3, wherein the content-change gesture is a gesture performed by using the first part or the second part.

5. The information display apparatus according to claim 1, wherein the controller is configured to change a position of the auxiliary image, following a movement of the first part or the second part onto which the auxiliary image is superimposed in the external field image.

6. The information display apparatus according to claim 1, wherein the controller is configured to end display of the auxiliary image in a case in which the gesture detector detects, while the auxiliary image is displayed, an end gesture that indicates an instruction to end display of the auxiliary image.

7. The information display apparatus according to claim 1, wherein the first part and the second part are on a lateral same side of the user.

8. The information display apparatus according to claim 2, wherein the controller is configured to change the first auxiliary image or the second auxiliary image to another auxiliary image in a case in which the gesture detector detects a content-change gesture that indicates an instruction to change displayed content while the first auxiliary image or the second auxiliary image is displayed.

9. The information display apparatus according to claim 8, wherein the content-change gesture is a gesture performed by using the first part or the second part.
